(19) United States
(12) Patent Application Publication
(10) Pub. No.: US 2026/0304046 A1
(43) Pub. Date: Oct. 1, 2026

(54) METHOD OF OPERATING A HEARING AID AND HEARING AID

(71) Applicant: Sivantos Pte. Ltd., Singapore (SG)

(72) Inventors: Tobias Wurzbacher, Erlangen (DE); Thomas Kübert, Erlangen (DE); Stefan Petrausch, Erlangen (DE)

(21) Appl. No.: 19/089,913

(22) Filed: Mar. 25, 2025

(51) Int. Cl. H04R 25/00

(52) U.S. Cl. CPC H04R 25/505; H04R 2225/41; H04R 2225/43; H04R 2430/01

(57) ABSTRACT

The procedure for operating a hearing aid involves the following steps:

Processing of an incoming hearing signal with the aid of signal processing and outputting of a processed hearing signal which is at least in parts shifted by a frequency shift with respect to the incoming hearing signal and which is amplified by an initial amplification factor,

Determining an amplitude ratio of the direct hearing signal and the processed hearing signal at a place of superposition where the two hearing signals superpose in a user's ear,

Adjusting the initial amplification factor for the processed hearing signal depending on the amplitude ratio.

This reduces or avoids unwanted artifacts caused by a superposition of the processed hearing signal and the direct hearing signal at the place of superposition (eardrum).

### BACKGROUND OF THE INVENTION

### Field of the invention

The invention relates to the operation of a hearing aid and to such a hearing aid.

### Description of the Background Art

In the present case, the term hearing aid generally refers to devices worn on the ear or in the ear or generally on the head. The hearing aid serves to process hearing signals and to transmit the processed hearing signals to a user. The hearing aid is, for example, a conventional headphone. In particular, the hearing aid is a hearing aid designed to assist a hearing-impaired person. Such hearing aids generally have a signal processing unit, with the help of which an incoming hearing signal is processed according to the user-specific hearing impairment and delivered to the user as a processed hearing signal. This typically involves an individual amplification of the incoming hearing signal which is dependent on the user's hearing impairment and the acoustical properties of the involved hearing aid hardware, including the acoustical coupling of hearing aid and ear-drum.

When processing the incoming hearing signal, at least parts of this incoming hearing signal are shifted in frequency in order to avoid or at least reduce unwanted artifacts. An example of such an artifact is feedback, in which the processed and output hearing signal is detected and processed again as an incoming hearing signal via a feedback path.

When using a hearing aid, the situation often arises where, in addition to the processed hearing signal, a so-called direct hearing signal is also perceived by the user, so that the processed hearing signal emitted by the hearing aid overlaps with the direct hearing signal at a place of superposition.

For example, the direct hearing signal reaches the place of superposition directly and unprocessed via open channels, for example via an open ventilation channel of the hearing aid or via an open channel between the hearing aid and the ear or via bone conduction.

Due to the frequency shift of the processed hearing signal in comparison to the incoming hearing signal and thus also in comparison to the direct hearing signal, an undesirable superposition of the signals occurs, resulting in amplitude modulation, which is perceived by the user as an unpleasant and disturbing artifact, namely as a rattling or wobbling sound.

### SUMMARY OF THE INVENTION

An object of the invention is to provide a method for operating a hearing aid, in which such artifacts generated by the superposition are reduced or avoided. Another aspect of the invention is to provide a hearing aid with a signal processing unit designed to reduce or avoid such artifacts.

The first object of the invention is achieved by a method for operating a hearing aid with the following steps:

An incoming hearing signal is processed with the aid of, in particular, a digital signal processing unit and a processed hearing signal is generated and output. The processed hearing signal is shifted by a frequency shift and amplified by an initial amplification factor compared to the incoming hearing signal, at least in some parts of the hearing signal. In a further step, an amplitude ratio between a direct hearing signal and the processed hearing signal is determined, in particular at a place of superposition where the two hearing signals superpose in the ear of a user. The place of superposition is in particular the eardrum or alternatively the inner ear, for example in the case of bone conduction. Furthermore, the initial amplification factor for the processed hearing signal is adjusted depending on the previously determined amplitude ratio and a final amplification factor is set as a result. To determine the amplitude ratio, the signal amplitude of the direct hearing signal and the processed hearing signal at the place of superposition is determined, in particular by calculation.

The term “Adjusting the initial amplification factor as a function of (depending on) the amplitude ratio” means that the initial amplification factor is reduced, increased (or even is kept unchanged), depending on the amplitude ratio and preferably depending also on other evaluation criteria. The initial amplification factor which is adjusted in this way then forms the final amplification factor, which is reduced or increased compared to the initial amplification factor or alternatively remains unchanged. Even if the initial amplification factor remains unchanged this is a decision of the evaluation step which checks, if the amplitude ratio makes an adjustment of the initial amplification factor necessary or not.

The further object of the invention is achieved by a hearing aid with the following features:

The hearing aid has a signal processing unit, in particular a digital signal processing unit, which is designed to process an incoming hearing signal and to generate an outgoing, processed hearing signal. The signal processing unit is designed for this purpose in a manner known per se. In particular, it has one or more processors, memory components, etc., which are mounted on a printed circuit board, for example. An executable program is installed in this signal processing unit, via which control commands are generated which suitably control these components, namely processors, memory components, other electronic components, such as filter banks, signal filters, amplification components for signal amplification, etc., so that the desired process steps are carried out as described above and as described below.

The signal processing unit is set up amplify the incoming hearing signal it by an initial amplification factor and to shift the incoming hearing signal at least in parts by a frequency shift. This produces the processed hearing signal, which is at least in parts shifted by a frequency shift and amplified by the initial amplification factor.

The term “at least in parts” means that not necessarily the entire hearing signal is amplified and/or shifted in frequency, but only some parts of the hearing signal and in particular certain frequency bands are amplified and/or shifted. During signal processing, the incoming hearing signal is usually broken down into several frequency bands and each frequency band is processed individually, for example shifted in frequency and amplified with an individual amplification factor. A partial signal is therefore processed within each frequency band. At the end of signal processing, the various partial signals of the different frequency bands are combined to form the processed hearing signal.

In this context, an hearing signal is generally understood to be any signal that is perceptible to the human ear. As a rule, this is an acoustic hearing signal represented by sound waves. This might be a superposition of a direct hearing signal and a processed signal. In addition, or alternatively, however, the hearing signal can also be structure-borne sound, which is transmitted, for example, via bone conduction, in particular to the inner ear.

The incoming hearing signal is in particular an external acoustic signal (represented by acoustic sound waves), alternatively or additionally it is an own voice signal, for example when the user speaks. This own voice signal usually has acoustic signal components (represented by acoustic sound waves), which are then processed by the signal processing unit in a similar way to the external acoustic signals. In addition, the own voice signal regularly also has signal components (represented by structure-borne sound) that are transmitted via bone conduction or tissue. In the present case, the term “incoming hearing signal” refers in particular to the acoustic hearing signals that reach the hearing aid from outside. These are converted into electrical input signals by means of an acoustic-electrical input transducer (in particular a microphone), which are then processed in the digital signal processing unit. Finally, at the end of the signal processing unit, an electrical output signal is fed to an output transducer, which is in particular an electrical-acoustic output transducer (receiver) or alternatively an output transducer for generating vibrations, for example of a bone conduction receiver.

To determine the amplitude ratio, the amplitude of the direct hearing signal at the place of superposition is generally determined, in particular on the basis of the incoming hearing signal, using a suitable algorithm. The signal amplitude of the processed hearing signal at the place of superposition is also determined on the basis of the incoming hearing signal and the settings of the hearing aid, in particular by calculation using a suitable algorithm. Preferably, suitable transfer functions are used to determine both the signal amplitude of the direct hearing signal and the signal amplitude of the processed hearing signal at the place of superposition. This place is especially the ear drum of the user.

In the present case, a direct hearing signal is generally understood to be an hearing signal that is not processed by the hearing aid and which the user perceives, i.e. which arrives at the eardrum or at the inner ear, for example, in addition to the processed hearing signal. The direct hearing signal is in particular an acoustic sound signal that reaches the eardrum via an open channel. The open channel is, for example, a ventilation channel of the hearing aid itself or a channel between the hearing aid and the user's ear. In addition or alternatively, the direct hearing signal may comprise also structure-borne sound signal components which are transmitted via tissue or bone, for example, and which also reach the inner ear and/or the eardrum. The structure-born signal component is mainly active during own voice activity.

The calculation of the amplitude ratio and the adjustment of the amplification factor are carried out continuously and, for example, at regular intervals in the range typically from 0,25 ms to 20 ms

The inventive embodiment described here is based on the recognition that the amplitude modulation due to the superposition and the associated artifacts depend essentially on the amplitude ratio between the processed hearing signal and the direct hearing signal. Studies have shown that the amplitude modulation (perceived as wobbling for example) is strongest when the two amplitudes are equal. This artifact decreases with increasing amplitude ratio, i.e. this artifact is smaller the more the amplitudes differ. According to the invention, this knowledge is used by specifically adjusting the amplification factor as a function of the determined amplitude ratio.

The signal processing is initially carried out as usual. First, an initial amplification factor is selected, in particular on the basis of the user-specific hearing loss. The expected amplitude ratio between the hearing signal processed with this initial amplification factor and the direct hearing signal is then determined for this initial amplification factor. If the amplitude ratio is in a range in which the previously described artifact is to be expected, the initial amplification factor is specifically changed so that the resulting amplitude ratio between the processed hearing signal and the direct hearing signal is changed and is in a range in which the artifact is at least reduced. A gain offset is therefore applied to the initial amplification factor so that the final amplification factor is obtained with which the hearing signal is then amplified.

As described above, transfer functions are preferably used to determine the amplitude ratio, on the one hand for the direct hearing signal and on the other hand for the processed hearing signal. The respective transfer function mathematically maps the signal path on the one hand for the direct hearing signal and on the other hand for the processed hearing signal, namely for the signal path up to the assumed place of superposition, which is preferably the ear drum. The respective transfer function can be used to determine the respective signal amplitude of the processed hearing signal on the one hand and of the direct hearing signal on the other at the assumed place of superposition. These two signal amplitudes determined in this way are set in relation to each other in order to determine the amplitude ratio.

The determination of such transfer functions is generally known. For example, a standard head (KEMAR head) is used to determine the transfer function for the processed hearing signal. Alternatively, the transfer function is measured individually for the user. Here, for example, an “In-situ microphone” is used, that is a microphone, which is placed in the area of the eardrum, to determine the transfer function and the hearing signal arriving there is measured and set in relation to the incoming hearing signal for different frequency ranges. A transfer function for the direct (acoustic) sound can also be measured in the same way, for example, if the hearing aid is placed in the ear but is not active.

Transfer functions can also be determined for structure-borne sound, as described, for example, in the following article: “Influences of Bone Conduction and Air Conduction on the Sound of One's Own voice.”, Christoph Porschmann, published in ACUSTICA—axta acustica, Vol. 86(2000 ), pages 1038-1045.

In a preferred embodiment, the initial amplification factor is adjusted and the final amplification factor is set in such a way that the amplitude ratio is above a defined threshold value. As explained above, studies have shown that the undesirable artifacts are reduced as the amplitude ratio increases. The threshold value is preferably at least 6 dB, preferably at least 12 dB or at least 18 dB. It might be even 24 dB or even higher. At an amplitude ratio of more than 18 dB and in particular more than 24 dB, the undesired artifact is negligible or no longer perceptible.

Alternatively, in some embodiments it is useful to adjust the initial amplification factor such that the amplitude ratio is below a defined threshold. In each case the amplification is adjusted such that artifacts generated by the superposition are at least reduced.

The initial amplification factor is preferably only adjusted if the amplitude ratio is below a lower threshold value of, for example, 12 dB or 6 dB or even just 2 dB. If the amplification factor is above the lower threshold value, the initial amplification factor remains unchanged. That means that during the evaluation process it is decided not to amend the amplification factor.

In a preferred embodiment, the initial amplification factor is reduced. This measure prevents the output volume from being too high.

The initial amplification factor is alternatively increased in certain listening situations and depending on selected evaluation criteria, such as frequency.

In a preferred embodiment, the incoming hearing signal is split into different frequency bands using the signal processing unit, so that different partial signals are generated. A respective frequency-dependent amplitude ratio between the processed hearing signal and the direct hearing signal is determined for several of these frequency bands and partial signals. The respective signal amplitude is also determined for the direct hearing signal, in particular using the respective transfer function for the different frequency bands and thus depending on the frequency. An initial frequency-dependent amplification factor is then adjusted depending on the frequency-dependent amplitude ratio. The measures described above are therefore carried out individually for the different frequency bands. As a rule, a specific initial amplification factor is used for each frequency band, which is adjusted so that corresponding frequency-dependent final amplification factors are then applied for the various frequency bands.

In a preferred embodiment, the determination of the frequency-dependent amplitude ratio and the adjustment of the frequency-dependent, initial amplification factor is only carried out for some of the frequency bands, and in particular only for frequency bands above 750 Hz. This measure is based on the consideration that, that frequency shifting is typically not activated in lower frequency ranges, so that a determination of the amplitude ratio and an adjustment of the amplification factor can be dispensed with for these lower frequencies, thus saving computing power.

A respective frequency band has a width of 60 Hz to 400 Hz, for example. The frequency bands often have a bandwidth of 250 Hz. The split into the different frequency bands is carried out using a so-called filter bank, for example. In some cases, a second filter bank stage is added for a higher resolution. In this case scenario the bandwidth is typically 62,5 Hz

In a preferred embodiment, the signal processing unit is designed to recognize the user's own voice and to switch to a own voice mode if the user's own voice is recognized. For this the signal processing unit comprises an own voice detection unit which is already known. In the own voice mode other calculation bases, in particular other mathematical algorithms and especially other transfer functions are used to determine the amplitude ratio (compared to a situation in which there is no own-voice situation). In general, switching into the specific own voice mode considers a situation in which the user speaks himself or makes sounds in general. Such own-voice situation is clearly different from a listening situation in which only external hearing signals reach the user's ear. In particular, the situation for the direct hearing signal is different. In an own voice situation, the perceived own voice usually consists of an acoustic signal component and a structure-borne sound signal component. The acoustic signal component is perceived by the ear like an external acoustic signal. The structure-borne sound signal component, on the other hand, is transmitted directly to the ear via tissue/bone.

Preferably, both an acoustic sound and a structure-borne sound are considered to determine the direct hearing signal-especially in such own voice situation. Preferably, a transfer function is used for both the acoustic sound components and the structure-borne sound components in order to determine the signal amplitude of the acoustic sound and the structure-borne voice sound of the own voice at the place of superposition.

Preferably, it is first determined whether the acoustic sound or the structure-borne sound is dominant and therefore forms a dominant sound component, whereby only the dominant sound component is then used to determine the amplitude ratio. The other sound component is therefore not considered, which means that the sound amplitude of the other sound is not used for calculation the amplitude ratio. Only the signal amplitude of the dominant sound component is used for determining the amplitude ratio. The dominant sound component is in general the sound that has the higher signal amplitude (in the respective frequency band), for example.

Alternatively, both the contribution (the signal amplitude) of the acoustic signal and the structure-borne sound are considered and combined to determine the amplitude ratio. In particular, a combined transfer function is used here, in which both the structure-borne sound and the acoustic sound are represented via the transfer function. At least the determined signal amplitudes of the both sound components are superposed. Therefore, a total amplitude of the acoustic sound and the structure-borne sound is first determined and the amplitude ratio is then determined using this total amplitude.

Preferably, the structure-borne sound is only considered if an own voice situation has been detected. This means that in cases where no own voice has been detected, only an acoustic sound is considered for the direct hearing signal. Determining the transfer function is therefore much simpler (in the normal mode, different from the own voice mode). Therefore, the structure-borne sound signal components are neglected as a first approximation.

Preferably, the frequency shift is changed depending on the amplitude ratio. The frequency shift by which the outgoing, processed hearing signal is shifted in relation to the incoming hearing signal is therefore changed. This measure is preferably also frequency-dependent. This change in the frequency shift (at least in parts of the signal, i.e. preferably at least in some of the frequency bands) is carried out in particular when it is not possible or difficult to adjust the amplification factor. This applies to situations in which adjusting the amplification factor would, for example, lead to further artifacts or the audibility of important signal components would be too strongly influenced. Another preferred criterion for changing the frequency shift is that a frequency shift, for example in a specific frequency band, is not required for the current listening situation. For example, this may be the case if feedback is to be avoided via the frequency shift, but feedback is not to be expected in the current listening situation.

Therefore, in some hearing situations first the amplitude ratio is determined. Then it is checked if the amplification factor can be changed (gain offset). If this is not possible due to some reasons or if the possible gain offset is not enough, it is checked if a change of the frequency shift is applicable, and if so, the frequency shift is amended.

This measure is based on the consideration that the annoying amplitude modulation can also be changed, for example, by a slight change in the frequency shift so that it no longer has a disturbing effect or is less disturbing. The frequency shift is typically in the range of a few Hertz, for example in the range of 5-50 Hz and often typically around 10 Hz. If, for example, a frequency shift of 10 Hz is changed to 5 Hz, this results in a slower variation of the amplitudes (time interval between high and low amplitude). Changing the frequency shift to a higher frequency, for example to 30 Hz, results in faster modulation (variation). In the case of static noise, a faster modulation is perceived as less disturbing, so that the unwanted artifact can be reduced by changing the frequency shift.

Preferably, both the initial amplification factor and the frequency shift are adjusted, at least in some hearing situations.

Preferably, a mapping is used for the determination and application of a specific gain offset for specific amplitude ratios. In this mapping the adjustment of the amplification factor, especially a gain offset, is stored as a function of the determined amplitude ratio. The mapping can be a table, for example. This mapping makes it easier to determine the necessary gain offset, i.e. to change the initial amplification factor. For example, less calculations, less computational cycles are necessary, which is beneficial for the power consumption.

Different mappings are preferably stored for different listening situations. This is based on the consideration that for certain listening situations, the artifacts caused by the superposition are particularly disturbing. This is the case, for example, with a tonal sound, such as that produced by musical instruments, children's voices, etc. For such listening situations, in which the artifacts are perceived as particularly disturbing, a more aggressive mapping is stored, for example, in which the gain offset is higher.

### BRIEF DESCRIPTION OF THE FIGURES

The present invention will become more fully understood from the detailed description given hereinbelow and the accompanying drawings which are given by way of illustration only, and thus, are not limitive of the present invention.

FIG. 1 shows a highly simplified representation of a hearing aid and a place of superposition at which a direct hearing signal and a processed hearing signal meet,

FIG. 2 illustrates in a block diagram the influence of an initial amplification factor as a function of the amplitude ratio and taking into account a mapping,

FIG. 3 shows an example of an amplitude ratio in relation to the frequency,

FIG. 4 shows an exemplary course of a gain offset for adjusting the initial amplification factor as a function of the amplitude ratio, in particular as a function of the amplitude ratio shown in FIG. 3, and

FIG. 5 shows the course of various transfer functions versus frequency.

### DETAILED DESCRIPTION

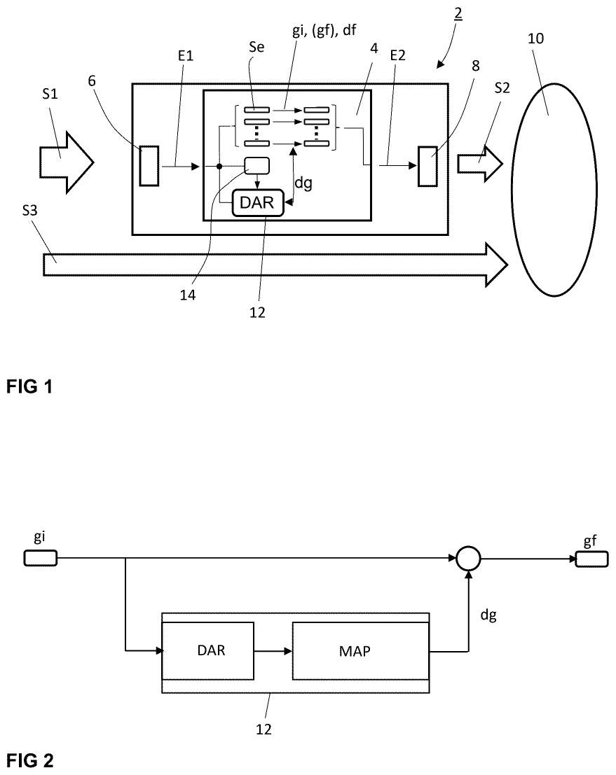

FIG. 1 shows a highly simplified representation of a hearing aid 2, with the aid of which an incoming hearing signal S1 is processed and then output as a processed hearing signal S2. The incoming hearing signal S1 is in particular an external acoustic sound signal and the processed hearing signal S2 is in particular a processed acoustic sound signal. For signal processing, the hearing aid 2 has a signal processing unit 4, an input transducer 6, an output transducer 8 and a large number of other components which are not shown in detail here. The hearing aid 2 is designed, for example, as a BTE (Behind The Ear), ITE (In The Ear), RIC (Receiver In Channel) or also as a bone conduction hearing aid. The functionality and design of such hearing aids 2 is generally known. The hearing aid 2 is worn on the user's head. In particular, at least part of the hearing aid 2 is placed in the user's ear. The ear, in particular the eardrum, forms a place of superposition 10 at which the processed hearing signal S2 coincides with a direct hearing signal S3 and is superimposed on it.

The input transducer 6 is, in particular, a microphone that is used to convert acoustic sound waves into an electrical input signal E1. This electrical input signal is transmitted to the (digital) signal processing unit 4, where the signal processing takes place. On the output side, the signal processing unit 4 emits an electrical output signal E2, which is transmitted to the output transducer 8. In particular, this is a receiver. This converts the electrical output signal E2 into the processed acoustic signal S2. This is emitted into the user's ear canal via a sound channel of the hearing aid 2.

Preferably, the hearing aid 2 is a hearing aid 2 for a hearing-impaired person, in which the signal processing therefore takes place depending on a user-specific hearing impairment, as is generally known.

The direct hearing signal S3 reaches the place of superposition 10 via an open bypass channel, for example, either through the hearing aid 2 or passing the hearing aid 2. During normal signal processing, the electrical input signal E1 is usually divided into several frequency ranges so that several electrical sub-signals Se are formed, each of which is processed individually depending on the user-specific hearing loss. In particular, the signal is amplified with a frequency-specific initial amplification factor gi for each frequency band, i.e. for each partial signal Se. Additionally, there is usually a frequency shift df in at least some frequency bands. This is, for example, in the range between 5 Hz and 50 Hz. The individual processed partial signals Se are then recombined and form the electrical output signal E2 described above, which is transmitted to the output converter 8.

A computing unit 12 is integrated in the signal processing unit 4, which is designed to determine an amplitude ratio DAR (direct to amplified ratio) between the direct hearing signal S3 and the processed hearing signal S2. For this purpose, a signal amplitude of the processed hearing signal S2 and a signal amplitude of the direct hearing signal S3 at the place of superposition 10 are determined on the basis of the incoming hearing signal S1 and, in particular, on the basis of the electrical input signal E1, using transfer functions T1, T2. This is preferably done frequency-dependently for each frequency band or alternatively for selected frequency bands (partial signals Se).

Depending on the determined amplitude ratio DAR, the frequency-dependent initial amplification factors gi are adjusted if necessary. For this purpose, a gain offset dg is specified via the computing unit 12. The gain offset dg is transmitted to a corresponding amplifier unit (not shown), so that a final gain factor gf is set.

The adjustment is made in such a way that the determined amplitude ratio DAR is above a threshold value of at least 6 dB, or of 12 dB or even 18 dB, for example. For example, the initial amplification factor gi is suitably reduced for this purpose.

An own voice detection unit 14 for recognizing the user's own voice is also implemented within the signal processing unit 4. Such units are known.

If an own voice situation is detected, this information is transmitted to the computing unit 12 and the system switches to an own voice mode. In this mode, a special transfer function T3 is used to determine the signal amplitude of the direct hearing signal S3. In such own voice situation, a structure-borne sound component is taken into account, as explained in more detail in the general description section.

FIG. 2 illustrates the adjustment of the initial amplification factor gi using the calculation unit 12. First of all, it is illustrated here that the initial amplification factor gi is a decisive influencing variable for determining the amplitude ratio DAR. In addition to a unit for determining the amplitude ratio DAR, a further unit (mapping unit) is also included for assigning a gain offset dg, in particular frequency-dependent, to the initial amplification factor gi. This assignment is referred to as mapping MAP. This gain offsets dg is combined with the initial amplification factor gi and, in particular, summed so that the final amplification factor gf is obtained.

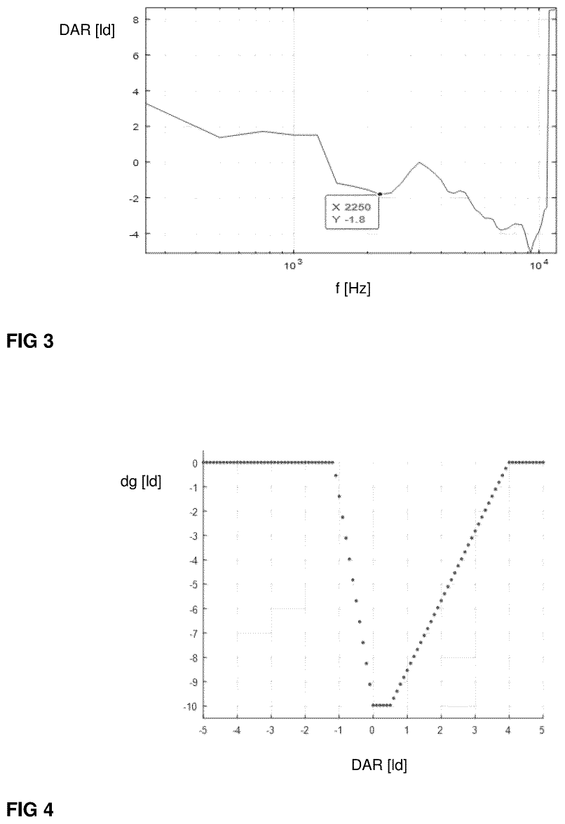

FIG. 3 shows an example of the amplitude ratio DAR plotted against the frequency. The amplitude ratio DAR and the frequency are each plotted logarithmically (logarithm dualis (Id) for the amplitude ratio DAR). As can be seen the amplitude ratio DAR varies depending on the frequency.

FIG. 4 shows an example of the mapping MAP. FIG. 4 shows the gain offset dg as a function of the amplitude ratio DAR. As can be seen, no gain offset dg is applied at higher amplitude ratios and the gain offset dg is only applied at low amplitude ratios.

Preferably, several such mappings MAP are stored for different listening situations. In the different mappings MAP the course of the gain offset dg differs. For example, the different mappings MAP differ with regard to the falling or rising edge of the gain offsets dg, so that in one case, for example, a softer adjustment is made and in the other case a sharper adjustment is made.

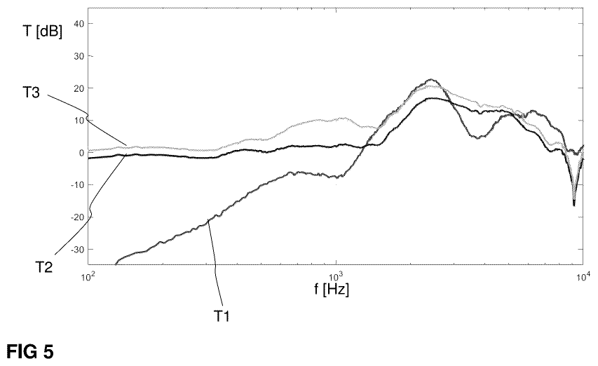

Finally, FIG. 5 shows examples of different transfer functions T1, T2, T3. T1 indicates the transfer function for the processed hearing signal S1 at a specified initial amplification factor gi, T2 indicates the transfer function for the direct hearing signal S3, namely for the pure acoustic sound without structure-borne sound. T3 specifies the transfer function for the direct hearing signal S3 as a superposition of acoustic sound and structure-borne sound.

The respective transfer function indicates the gain or the amplitude ratio or in general the modification of a signal from an input side of a signal path to an output side of the signal path. In the present case the transfer function T1 indicates the gain ratio or the amplitude ratio between the signal amplitude of the incoming hearing signal S1 and the processed hearing signal S2 at the place of superposition 10 as a function of the frequency. Transfer function T2 indicates accordingly the gain ratio or the amplitude ratio between the incoming hearing signal S1 and the direct hearing signal S3 at the place of superposition 10 as a function of the frequency. As can be clearly seen from FIG. 5, the transfer functions T1 to T3 show a strong frequency dependence. The frequency dependency can differ greatly between the various transfer functions T1, T2, T3, which leads to different, frequency-dependent amplitude ratios DAR.

### LIST OF REFERENCE SYMBOLS

2 hearing aid
4 signal processing unit
6 input converter
8 output converter
10 place of superposition
12 computing unit
14 own voice detection unit
S1 incoming hearing signal
S2 processed hearing signal
S3 direct hearing signal
E1 electrical input signal
E2 electrical output signal
Se electrical partial signal
df frequency shift
gi initial amplification factor
T1 transfer function for the processed hearing signal
T2 transfer function for the direct hearing signal
DAR amplitude ratio
MAP mapping

1. Method of operating a hearing aid comprising the following steps:
a) Processing of an incoming hearing signal with the aid of signal processing unit and outputting of a processed hearing signal which is at least in parts shifted by a frequency shift with respect to the incoming hearing signal and which is amplified by an initial amplification factor
b) Determining an amplitude ratio of the direct hearing signal and the processed hearing signal at a place of superposition where the two hearing signals superpose in a user's ear,
c) Adjusting the initial amplification factor for the processed hearing signal depending on the amplitude ratio.

2. The method according to claim 1, wherein a transfer function for the direct hearing signal and a transfer function for the processed hearing signal are used to determine the amplitude ratio.

3. The method according to claim 1, wherein the initial amplification factor is adjusted such that the amplitude ratio is above a defined threshold value.

4. The method according to claim 3, wherein the defined threshold value is at least 12 dB.

5. The method according to claim 1, wherein the initial amplification factor is reduced.

6. Method according to claim 1, wherein the incoming hearing signal is split into different frequency bands, so that different partial signals are generated and wherein a frequency-dependent amplitude ratio is determined for a plurality of the partial signals and wherein an initial amplification factor for each of the plurality of the partial signals is adjusted as a function of the frequency-dependent amplitude ratio.

7. The method according to claim 6, wherein the determination of the frequency-dependent amplitude ratio is carried out only for a part of the frequency bands.

8. The method according to claim 7, wherein the amplitude ratio is determined only for frequency bands above 750 Hz.

9. Method according to claim 1, wherein the signal processing unit is designed to recognize the own voice and is switched to an own-voice mode if the own voice is recognized.

10. The method according to claim 1, wherein both an acoustic sound and a structure-borne sound are considered for determining the direct hearing signal.

11. Method according to claim 10, wherein it is first determined whether the acoustic sound or the structure-borne sound is dominant and thus forms a dominant sound component, wherein subsequently only the dominant sound component is used to determine the amplitude ratio.

12. The method according to claim 10, wherein both the contribution of the acoustic sound and the structure-borne sound are combined for determining the amplitude ratio.

13. The method according to claim 9, wherein in cases where no own voice is detected, only an acoustic sound for the direct hearing signal and no structure-borne sound is considered.

14. Method according to claim 1, wherein the frequency shift is changed depending on the amplitude ratio.

15. Method according to claim 1, wherein a mapping is used in which a gain offset for an adjustment of the initial amplification factor is stored as a function of the determined amplitude ratio.

16. Method according to claim 15, wherein different mappings are stored for different hearing situations.

17. Hearing aid having a signal processing unit for processing an incoming hearing signal and for generating a processed hearing signal which is at least in parts shifted by a frequency shift with respect to the incoming hearing signal and which is amplified by an initial amplification factor, the signal processing unit having a computing unit which is designed to determine an amplitude ratio between the processed hearing signal and a direct hearing signal at place of superposition of the processed hearing signal and the direct hearing signal, the signal processing unit being set up to adjust the initial amplification factor as a function of the amplitude ratio.
